(19) United States
(12) Patent Application Publication
(10) Pub. No.: US 2011/0198524 A1
(43) Pub. Date: Aug. 18, 2011

(54) ACTUATOR, VALVE AND METHOD

(75) Inventors: Carl Wood, Aberdeen (GB); Runi Joensen, Aberdeen (GB); George Senkbeil, Aberdeen (GB)

(73) Assignee: NATIONAL OILWELL VARCO UK LIMITED, Lancashire (GB)

(21) Appl. No.: 13/027,400

(22) Filed: Feb. 15, 2011

(30) Foreign Application Priority Data
Feb. 15, 2010 (GB) 1002503.9

(51) Int. Cl. F16K 5/00; B21K 1/24

(52) U.S. Cl. 251/304; 29/890.12

(57) ABSTRACT

An actuator or valve includes an inner member; an outer member around the normally rotatable inner member; the inner member including normally two spaced apart outwardly extending projections abutting with the outer member; the outer member including normally two inwardly extending projections abutting with the inner member, the projections defining a chamber therebetween; and the actuator further including a fluid port in communication with the chamber. The actuator/valve is normally made by straight profile cutting. The compact rotary actuator may be remotely operated.

### RELATED APPLICATION

This application claims priority of British Patent Application No. 1002503.9, filed Feb. 15, 2010, herein incorporated by reference.

### TECHNICAL FIELD

This disclosure relates to an actuator, valve and method, particularly but not exclusively to a rotational valve for use in selectively directing hydraulic fluid.

### BACKGROUND

Rotational actuators and valves are known and one common application is to direct high pressure hydraulic fluid from a hydraulic fluid input to one of a number of different outputs, each corresponding to a different application. To do this, a lever on the valve is manually turned to rotate a distributor which then directs the hydraulic fluid to the desired hydraulic output.

While reasonably satisfactory, it would be preferred to be able to operate the actuator remotely.

### SUMMARY

We provide an actuator including an inner member and an outer member around the inner member, the inner and outer members being rotatable with respect to each other, wherein the inner member includes an outwardly extending projection abutting with the outer member, the outer member includes an inwardly extending projection abutting with the inner member, the projections defining a chamber therebetween, and the actuator further includes a fluid port in communication with the chamber.

We also provide a valve including the actuator, at least one inlet and at least one outlet.

We further provide a method of manufacturing an actuator or a valve including providing a piece of material, cutting a first member from the piece of material, and cutting a second member from the same piece of material, wherein the material is cut by profile cutting.

### BRIEF DESCRIPTION OF THE DRAWINGS

FIG. 1 is an exploded view of a valve comprising an actuator.

FIG. 2a is a second exploded view of the FIG. 1 valve, without an upper body.

FIG. 2b is a part-assembled view of the FIG. 1 valve, without the upper body.

FIG. 2c is a perspective view of the FIG. 1 valve in an assembled state.

FIG. 2d is a plan view of the FIG. 1 valve in a first rotational position with the upper body removed for illustration purposes.

FIG. 2e is a plan view of the FIG. 2d valve in a second rotational position.

FIG. 2f is a plan view of the FIG. 2e valve in a third rotational position.

FIG. 3 is a plan view of a rotor element of the FIG. 1 valve.

FIG. 4a is a plan view of a stator element of the FIG. 1 valve.

FIG. 4b is an enlarged view of the area B in FIG. 4a.

FIG. 5a is an exploded view of an actuator.

FIG. 5b is a perspective view of the FIG. 5a actuator in an assembled state.

FIG. 5c is a plan view of the FIG. 5a actuator in a first rotational position with the upper body removed for illustration purposes.

FIG. 5d is a plan view of the FIG. 5c actuator in a second rotational position.

FIG. 5e is a plan view of the FIG. 5c actuator in a third rotational position.

FIG. 6 shows a series of rotors and stators, each pair being cut from the same piece of material.

### DETAILED DESCRIPTION

We provide an actuator comprising:
an inner member;
an outer member around the inner member;
the inner and outer members being rotatable with respect to each other;
the inner member comprising an outwardly extending projection abutting with the outer member;
the outer member comprising an inwardly extending projection abutting with the inner member, the projections defining a chamber therebetween; and
the actuator further comprising a fluid port in communication with the chamber.

We thus provide a hydraulically activated actuator which may be activated remotely. In particular, we provide for this in a space efficient and cost effective manner.

The inner member (excluding the projection) is preferably substantially circular in shape, more preferably circular-ring shaped.

The outer member is preferably circular-ring shaped.

Normally, only one of the inner and outer members rotate and the other is stationary relative to an outer body. Preferably, the inner member is rotatable while preferably the outer member is stationary relative to the outer body. Whichever of the inner and outer members which rotates is referred to as the “rotating member.”

The actuator normally has a mechanism to couple the rotating member to an external device. For example, the rotating member may be fixed to a drive shaft by a locating key and the drive shaft may extend out of the outer body and an end of the drive shaft fixed in use to an external device.

The projections typically extend for the entire axial height of the inner and outer members, the axis defined by the rotational axis of the inner or outer member.

Normally, two chambers are defined around the circumference of the inner member and are defined by the two projections. For example, in one position, the projections may be spaced apart by 90 degrees, thus defining a first chamber between the projections extending for around 90 degrees, and a second chamber extending for around 270 degrees. In practice, they will be slightly less depending on the radial length of the projections. Preferably, each projection extends for 30-60 degrees, preferably 40-50 degrees.

Indeed, preferably the inner member has two (or more) outwardly extending projections, typically opposite each other and preferably the outer member has two (or more) inwardly extending projections, typically opposite each other. Thus, in such instances, four (or more) chambers are defined between the projections.

Preferably, a fluid port is in communication with each chamber. Typically, the each fluid port is a control fluid port. The fluid port may be an inlet or an outlet, but can preferably be operable as both. In use, hydraulic fluid can be injected or removed from the chambers through the ports. In a normal operation, this drives rotation of the inner and outer members with respect to each other. The rotational drive generated, referred to hereinafter as “torque,” is proportional to the area of the chambers, particularly the chambers' width, that is the distance between the inner and outer members. By alternating the injection between the different chambers, the rotating member can be made to reciprocate.

However, alternatively, the actuator may be operated to work in reverse, receiving an outside force to rotate the inner and outer members with respect to each other to produce a surge of fluid from the chambers.

The use of two projections in each of the inner and outer members is preferred since this provides a more balanced rotational force in use. Further projections may also be added. Often, the rotating member is limited to adopting the number of positions corresponding with the number of chambers and so, for applications requiring the rotor to adopt more positions, further projections can be utilized.

Further, positions can also be achieved by nesting a further member inside or outside the inner or outer member, as described in more detail below.

Preferably, the inwardly and outwardly extending projections are arranged such that they alternate between inwardly and outwardly extending projections. That is, preferably, there are not two inwardly or two outwardly extending projections in sequence.

For the sake of clarity, when referring to the inwardly extending projection of the outer member, or the outwardly extending projection of the inner member, the “other member” as referred to hereinafter is the member to which the projection abuts, that is the inner member and the outer member, respectively.

The portion of the projection abutting the other member is referred to as a “bearing face” (of the projection). Typically, the bearing face of the projection has a complementary shape, typically arcuate, with that of the other member.

The inwardly extending projection of the outer member preferably has a shoulder extending outwardly therefrom, preferably two shoulders extending outwardly from each end. The shoulders are preferably a continuum of the bearing face of the projections. Thus, each shoulder defines a groove between the shoulder, projection and the outer member.

Typically, the inner and outer members are concentric.

Rotation as used herein normally means part-rotation, that is less than 360 degrees since full rotation is limited, at least, by the projections on the inner and outer members abutting with each other.

Preferably, a retention mechanism is provided to retain the rotor in a stationary position when rotation is not intended. The retention mechanism may be a spring loaded ball and a detent, each provided on one of the rotating member and a stationary part of the actuator. For example, the spring loaded ball may be provided on a lower body and the detent on the rotor. On activation of the rotor, sufficient torque is typically generated to overcome the force exerted by the retention mechanism.

Optionally, a manual lever is included as a back-up to turn the rotor if required.

In certain instances, a further member is added having a projection extending towards the inner or outer member and thus defining a further chamber between the further member and either the inner or outer member which have an extra projection extending towards the further member. It will be appreciated that the direction of the projection of the further member will depend on whether the further member is inside of the so-called “inner member” or outside of the so-called “outer member.” The closest member to the further member, for example, the so-called “inner member” when the further member is placed thereinside, is referred to as its “adjacent member.” Relative rotation between the further member and its adjacent member is actioned in the same manner as described above with respect to the inner and outer members and their preferred and optional features should be understood to be preferred and optional features for the further member and its adjacent member. Indeed, any number of further members may be added each rotating relative to its adjacent member. One advantage is increasing the overall degree of rotation available to the actuator, since simpler versions having only the inner and outer member and with the preferred two projections on each can normally rotate by less than 180 degrees. Moreover, more discrete positions for an output to control an external device, such as a valve, can be achieved.

In use, the torque generated by the rotating member is normally directly governed by the pressure difference generated across the projections and, therefore, normally directly governed by the seal achieved between the projections and the other member which in turn depends on the clearance between the projections and the other members. Normally, clearance is eliminated by use of elastomer seals, but we prefer to tightly control the sizing of the projections and the other member, while any leakage flow and pressure loss can be managed.

Some benefits is that they provide rotary actuation in a small space envelope without any requirement for elastomer sealing on the inner and outer members. Thus, preferably, there is no further seal provided between the outwardly extending projection and the outer member. And, preferably, there is no further seal provided between the inwardly extending projection and the inner member.

This is in marked contrast to the accepted practice in this field, which is to provide seals, such as o-ring seals, where two components abut and move with respect to each other. Our devices provide for the longevity of the actuator to be increased since such seals are not included, and these seals tend to wear before other components of the actuator.

Since the actuator is pulsing in nature, the pressure difference is only required for the duration of the rotation, so only a temporary dynamic seal is required. Therefore, by increasing the tolerance control on the projections as well as the thickness and flatness of the rotor and stator, this aids the actuator in providing sufficiently high torques and swift motion without the use of elastomer seals on the rotor.

The abutment between each projection and the other member is normally an extremely tight tolerance. Preferably, there is less than about 0.254 cm, more preferably less than about 0.0254 cm, especially less than about 0.00254 cm, and may be up to about 0.000254 cm or less between the projection and the other member.

The clearance can also vary with the size of the rotor diameter (calculated including the projections). Preferably, the clearance between the projection and the other member is less than about 0.25% of the rotor diameter, more preferably less than about 0.025% and may be less than about 0.0025%.

In use, the actuator can be connected to another device to actuate the device. The actuator can be provided on collars, mechanical locks, valves or other devices.

The actuator can also be used to translate rotary motion into linear motion via a camshaft.

We also provide a valve comprising the actuator and at least one inlet and at least one outlet. Normally there is one inlet.

Where the actuator is provided with a valve, typically at least one of the inner and outer members comprises a distributor,
the distributor being in fluid communication with one of the inlet and the outlet, and rotatable between a first position, where it is also in fluid communication with the other of the inlet and the outlet, and a second position where fluid communication with the other of the inlet and outlet, is reduced.

Thus, we also provide a valve comprising:
at least one inlet;
at least one outlet;
an inner member;
an outer member around the inner member;
   wherein at least one of the inner and outer members comprises a distributor,
the distributor being in fluid communication with one of the inlet and the outlet, and rotatable between a first position, where it is also in fluid communication with the other of the inlet and the outlet, and a second position where fluid communication with the other of the inlet and outlet, is reduced,
the inner member comprising an outwardly extending projection abutting with the outer member;
the outer member comprising an inwardly extending projection abutting with the inner member, the projections defining a chamber therebetween; and
the valve further comprising a fluid port in communication with the chamber.

Normally, there is one inlet.

Normally, the distributor is in fluid communication with the inlet and rotatable between a first position, where it is in communication with the outlet, and a second position where fluid communication with the outlet is reduced. However, in less preferred alternatives, the distributor is in fluid communication with the outlet and rotatable between a first position, where it is in communication with the inlet, and a second position where fluid communication with the inlet is reduced.

Preferably, at least one of the inner and outer members comprises a distributor and preferably the other of the inner and outer members is a stator. The stator typically remains stationary in use. Preferably, the outer member is the stator.

Preferably, the inner member comprises the distributor. In any case, preferably, the member comprising the distributor is formed in two parts, one part comprising the distributor and the other part comprising the projections. The parts are typically held together in use such that relative movement between the parts is prevented. An advantage is that the preferred precise size of the projections can be manufactured in one part while the internal configuration of the distributor can be manufactured in another part, which we consider to be more efficient than forming the distributor and the part comprising the projections as a single manufactured piece.

The second position where fluid communication with the at least one inlet/outlet is reduced may be any position which regulates the flow of fluid from or to the inlet/outlet in use and thus the valve may work as a proportional valve. However, more preferably, the position where the fluid communication is reduced is a position where the distributor is not in fluid communication with the at least one inlet/outlet and therefore is essentially a valve-closed position. Thus, the valve may function as an on/off valve. Still more preferably, however, there is more than one outlet and the second position also opens fluid communications with a second outlet while simultaneously reducing fluid communication with the first outlet, preferably stopping fluid communication with the first outlet. While there is normally one input, a number of separate outlets may be provided and, preferably, the distributor is added to rotate so that it can take up more than two positions, each position selectively in communication with any one of the outlets.

Preferably, the inner member and outer member were cut from the same piece of material. In this way, any variations in thickness, flatness and/or surface finish are minimized.

Thus, we provide a method of manufacturing an actuator or a valve, the method comprising:
providing a piece of material;
cutting a first member from the piece of material; and
cutting a second member from the same piece of material.

Preferably, the material is cut by profile cutting. Preferably, the cutting is in a single straight line or plane, that is directly from an arbitrary position ‘a’ to an arbitrary position ‘b’ into, and typically through, the piece material, and preferably therefore does not deviate from the straight line or plane.

A plurality of separate cuts may be performed.

Typically, the first member is cut from the material at an area which is surrounded by the area which is cut to form the second member.

Preferably, no grinding is required. Preferably, no milling is required. Preferably, no facing is required. Preferably, no other processes are conducted which may introduce set-up inaccuracies and misalignment and require extended machining time.

To achieve preferred tolerances, the piece of material used to form the first member and second member is preferably cut using the technique known as Electrical Discharge Machining (EDM). This known, but highly specialized technique can provide a suitable tolerance between the first and second member. An EDM machine may be obtained from Agie Charmilles Ltd, Coventry United Kingdom.

Preferably, the piece of material is cut from standard ground tool-steel stock. This plate material is readily available (for example, from RS Components, Corby, UK) which is pre-manufactured to have a very tight tolerance on thickness, flatness and roughness.

Preferably, the first and second members which have been cut from the same piece of material are marked as a pair and used in the same actuator or the same valve.

Preferably, the actuator may comprise a first member and a second member moveable, preferably rotatable, with respect to each other.

Preferably, the actuator may comprise a first member comprising projections abutting with a second member.

Preferably, the second member comprises projections abutting with the first member.

Preferably, the projections define a chamber therebetween and, preferably, the actuator comprises a fluid port in communication with the chamber.

Preferably, the first member is an inner member. Preferably, the second member is an outer member.

Preferably, therefore, the actuator or valve is the actuator or valve and preferred and other optional features are to be regarded as preferred and optional features in other instances.

In instances comprising further members rotatable with respect to adjacent members, all further members are preferably also cut from the same piece of material as the so-called “inner” and so-called “outer member.”

A further advantage of such a technique is that any variation in thickness, flatness and/or surface finish are minimized.

Preferably, the method is fully automated so the inner and outer members can be readily batch produced out of large stock plates without need to re-setup the machine, minimizing labor costs.

Normally, we operate using a pressure within the chambers in the range of 100-10,000 psi, preferably 200-5,000 psi, more preferably 300 psi to 3,000 psi.

Selected, representative examples will now be described with reference to the accompanying figures.

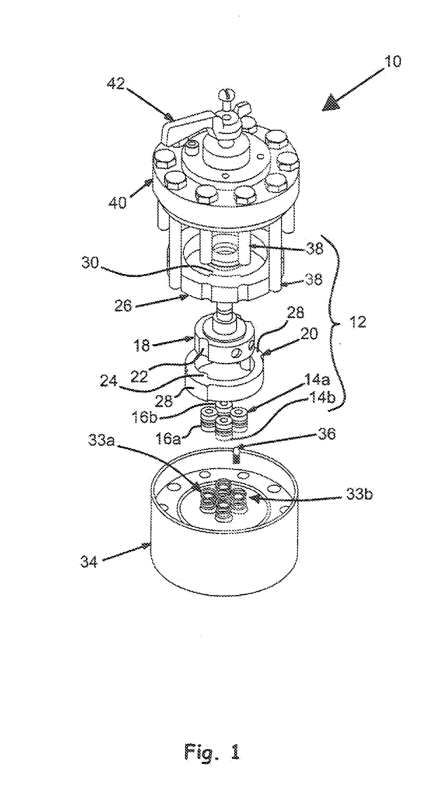

FIG. 1 shows an exploded view of a valve 10 comprising an actuator 12. The valve 10 has two input or supply lines 14a, 14b corresponding to activation of external devices A and B (not shown), a pressurized line 13 from a hydraulic pump (not shown) and a return line 16. A distributor 18 receives the lines 13, 14a, 14b, 16 in a bottom face thereof and has internal piping (not shown) which allows these lines to fluidly communicate depending on the rotational position of the distributor 18 to selectively direct fluids to activate one of the external devices A or B.

The distributor 18 is provided in a substantially ring-shaped rotor 20 and indents 22 on a circumferential edge of the distributor 18 locate in notches 24 provided on the inner face of the rotor 20 to prevent rotation between the two components.

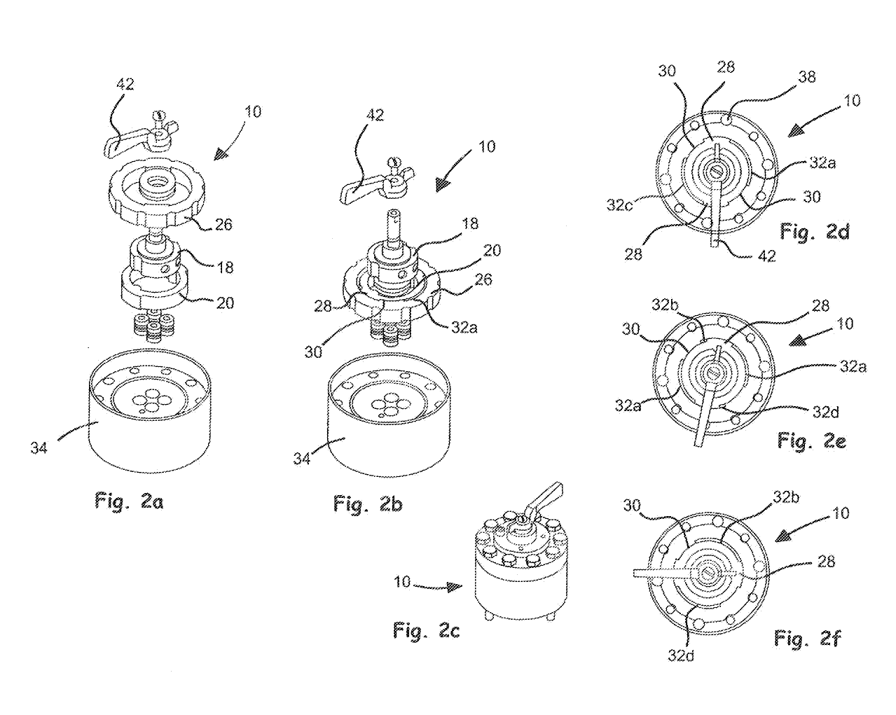

The rotor 20 is located inside a generally ring-shaped stator 26. The rotor 20 has two opposite projections 28 extending outwardly from a circumferential edge thereof which abuts and forms a seal with an inner face of the stator 26. The stator 26 has two inwardly extending projections 30 which form a seal with an outer face of the rotor 20. Notably, no further seals, such as o-ring seals are required. Thus, between the respective projections of the rotor 20 and stator 26 are defined chambers 32a-32d (shown in FIGS. 2a-2d) into which hydraulic fluid may be added from control fluids ports 33a-33d to drive rotation of the rotor 20, as described in more detail below.

The valve 10 is secured to a lower body 34 with springs urging the fluid lines 13, 14a, 14b, 16 towards the distributor and a spring loaded ball 36 for location in a detent (not shown) of the distributor 18 which functions to retain the distributor in a rest position when torque is not being activated. An upper body 40 is provided over the actuation mechanism 12 and the valve fixed together using a plurality of hexagonal bolts 38. A lever 42 is provided as a back-up to allow the rotor 20 to be turned manually, if required.

FIG. 2a is a further exploded view of the valve 10 and FIG. 2b shows a partially assembled view. In FIG. 2c the assembled valve 10 is shown.

The chambers 32a-32d can be seen in FIG. 2d, defined by the outwardly extending projections 28 of the rotor 20 and the inwardly extending projections 30 of the stator 26. In the position shown in FIG. 2d the distributor 18 aligns the input 14a with the supply line 13 and the input 14b with the return line 16 to activate the external device A while external device B is inactive. The chambers 32a-32d are not under pressure when the rotor 20 is stationary.

To rotate the rotor 20 and enclosed distributor 18, the control ports 32a, 32c are pressurized and the ports 32b, 32d are vented. This produces torque and caused the rotor 20 and distributor 18 to rotate in a clockwise direction, as viewed in FIG. 2e. The stator 26 and the inwardly extending projections 30 thereon remain stationary during the rotation of the rotor 20. The rotor 20 continues to rotate until the outwardly extending projections 28 abut with the inwardly extending projections 30, as shown in FIG. 2e. The chambers 32a, 32c can then be depressurised. The distributor 18, which turns with the rotor 20, thus aligns its internal porting to allow the input 14b to communicate with the supply line 13, and the input 14a to communicate with the return line 16 thus deactivating external device A and activating external device B.

Thus, various of our structures can be used to hydraulically activate a rotational valve to switch from supplying fluids for one purpose, corresponding to input 14a to another purpose corresponding to input 14b.

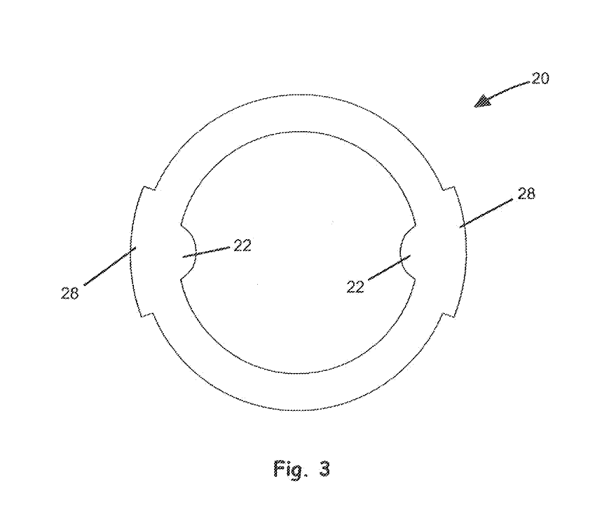

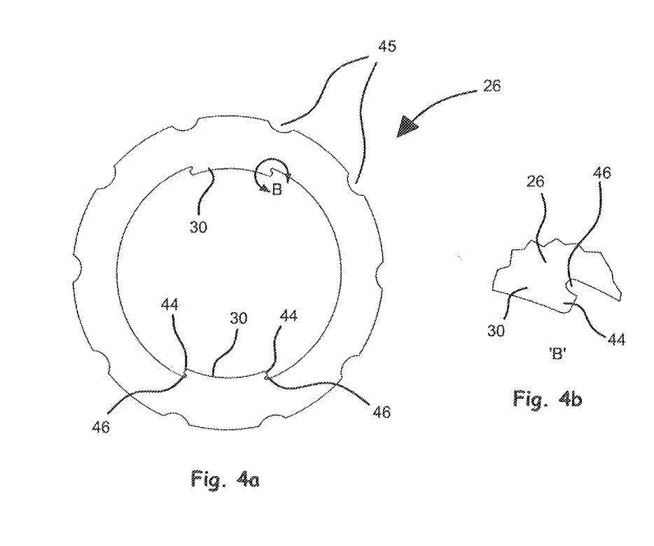

The rotor 20 is shown in more detail in FIG. 3 showing notches 24, for location with the distributor 18 and projections 28. FIG. 4a shows the stator 26 with the inwardly extending projections 30. Notches 45 are provided in the circumferential edge for location with the hexagonal bolts used to assemble the overall valve 10. As shown in an enlarged view of FIG. 4b, the projections 30 have shoulders 44 extending from the outer edge thereof thus defining a groove 46. The groove 46 and shoulders 44 prevent the control ports 32a-32d from being blocked when the inwardly and outwardly extending projections abut each other during use.

To manufacture the stator 26 and rotor 20 a particular manufacturing process is preferred.

The stator 26 and rotor 20 are formed from the same block or piece of material. The material is a precision ground flat stock (of variable thickness), fully annealed and suitable for hardening with excellent dimensional stability and wear resistance. Thickness and flatness tolerance typically +0.001″-0.001″.

The rotor 20 is profile-cut from a block (not shown) of the ground tool-steel stock and a stator 26 is profile-cut from the same block surrounding the void left by the rotor which has been cut thereform. A portion of the outer face of the stator 26 (which represented the gap between the rotor piece and the stator piece in the original block of material) is then profile-cut away to leave the stator 26.

This ensures that variation in thickness, flatness and surface finish are minimized. No grinding, milling, facing or other processes are required.

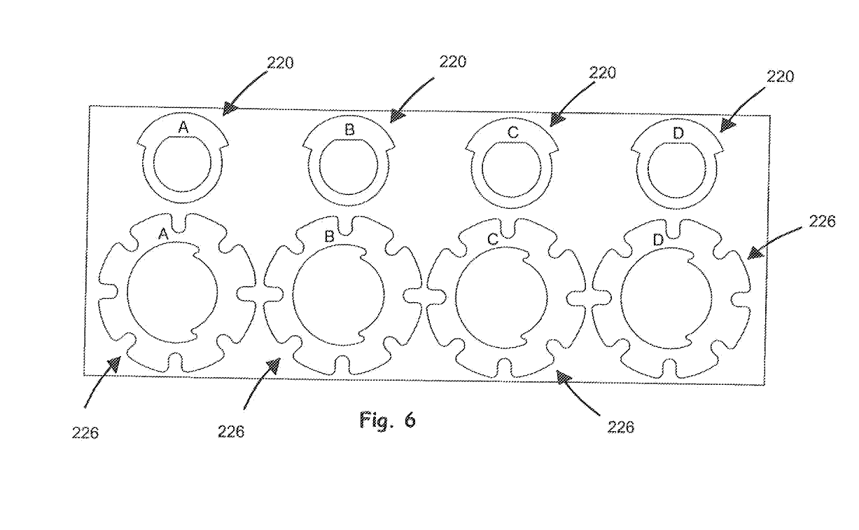

The cutting is performed using the technique of Electrical Discharge Machining which can produce a very accurate profile-cut in the piece of material. FIG. 6 shows a series of rotors 220 and stators 226, each pair being cut from the same piece of material.

Aternatively, the stator 26 is first cut from the material and then the rotor 20.

In use, benefit can be achieved in that the shoulders interfacing with the stator or rotor 20 are very close together. This obviates the need for o-ring seals and, thus, lengthens the durability of the actuator.

While some very small clearance is required between the shoulders and interfacing rotor 20 or stator to allow it to move, any leakage through this interface can be managed, noting the actuator will only be under dynamic pressure during rotation.

Another advantage such as that shown in the preceding figures, is that the projections are evenly spaced around the circumference of the rotor 20/stator 26. Alternatively, three or more projections may be provided on each of the stator and rotor. This even spacing allows the rotor and stator to be “floating” in relation to other parts and the forces driving the rotation to be balanced at the center point. The rotor drives an actuated part, such as a distributor, but the clearance gaps between these two parts can be one, two or more orders of magnitude greater than between the rotor and stator. This ensures that the rotor/stator pair is a “floating” entity inside a greater assembly and that aspects such as shaft concentricity, bearing location and others are independent of this design. This greatly simplifies the actuator design.

Moreover, this reduces wear of the components and also reduces the likelihood that a rotor will stick during rotation. Also, replaceable elastomer seals are not required.

Due to the floating nature of the rotor and stator pair, the component wear is reduced significantly, resulting is a greatly prolonged service life.

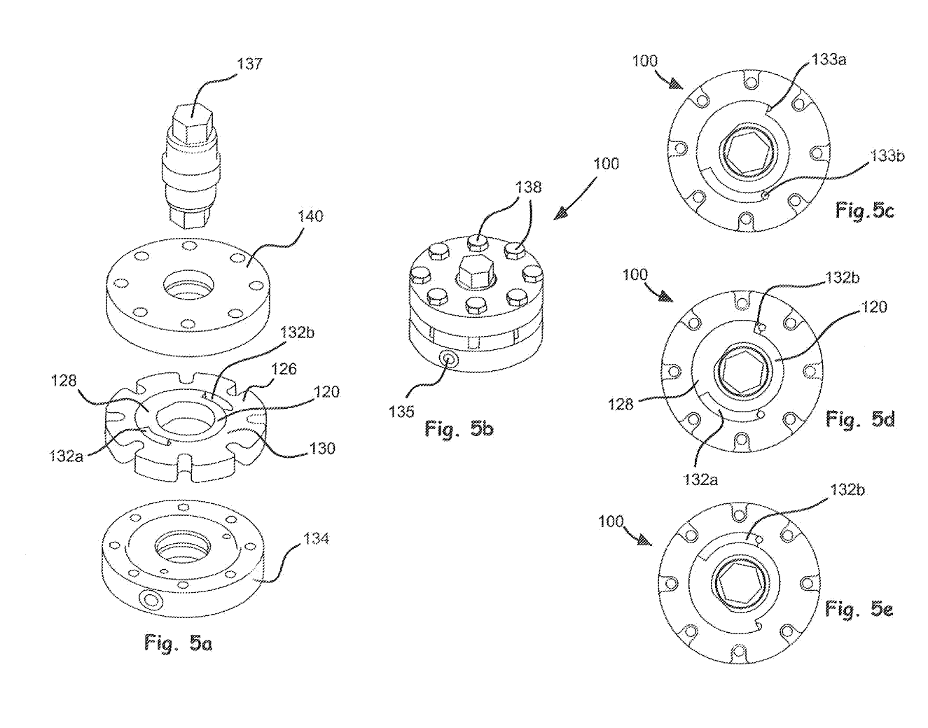

While it is preferred to have a plurality of projections from each of the rotor and stator, it is not necessary and FIGS. 5a-5e show an actuator where only a single projection from each of a stator and rotor is used. FIG. 5 also relates to an actuator which may be coupled to other items, not just valves. It will be appreciated that the devices illustrated in the preceding figures could equally be adapted to function as an actuator for items other than valves.

An exploded view of actuator 100 is shown in FIG. 5a comprising a stator 126 having an inwardly extending projection 130 and a rotor 120 having an outwardly extending projection 128, thus defining chambers 132a, 132b between the projections 128, 130. Other components include a shaft 137, side bolts 138, a control fluid input 135, an upper body 140 and a lower body 134.

The assembled actuator is shown in FIG. 5b and a plan view in FIG. 5c. The actuator 5 is operated in a similar manner to that described above for the earlier embodiment—hydraulic fluid is added through a control port 133 and an opposite control port 133b is vented. This causes the rotor 120 to rotate in an anti-clockwise direction as viewed and rotate the shaft 137. FIG. 5d shows a 10 degree rotation and FIG. 5c shows a 90 degree rotation. The shaft 137 can be attached to an external device and the rotation used to activate a switch, block, collar or for other purposes.

Thus, we provide a low cost rotary actuator in a confined space which can produce a significant amount of torque strength.

Although the apparatus and methods have been described in connection with specific forms thereof, it will be appreciated that a wide variety of equivalents may be substituted for the specified elements described herein without departing from the spirit and scope of this disclosure as described in the appended claims.

1. An actuator comprising:
an inner member;
an outer member around the inner member;
the inner and outer members being rotatable with respect to each other;
wherein the inner member comprises an outwardly extending projection abutting with the outer member;
the outer member comprises an inwardly extending projection abutting with the inner member, said projections defining a chamber therebetween; and
the actuator further comprises a fluid port in communication with said chamber.

2. The actuator of claim 1, wherein the inner member is rotatable while the outer member is stationary relative to the outer body.

3. The actuator of claim 1, wherein each projection extends for about 30 to about 60 degrees.

4. The actuator of claim 1, wherein the inner member has two or more outwardly extending projections and the outer member has two or more inwardly extending projections.

5. The actuator of claim 1, wherein there is less than about 0.00254 cm between the projection and the member to which the projection abuts.

6. The actuator of claim 1, further comprising a further member having a projection extending towards the inner or outer member and defining a further chamber between the further member and either the inner or outer member which has an extra projection extending towards the further member.

7. The actuator of claim 1, wherein the actuator translates rotary motion into linear motion via a camshaft.

8. The actuator of claim 1, wherein, in use, hydraulic fluid is injected into the chamber to drive rotation of the inner and outer members with respect to each other.

9. The actuator of claim 1, wherein, in use, an outside force rotates the inner and outer members with respect to each other, producing a surge of fluid from the chamber.

10. A valve comprising the actuator as claimed in claim 1, comprising at least one inlet and at least one outlet.

11. The valve of claim 10, wherein at least one of the inner and outer members comprises a distributor in fluid communication with one of the inlet and the outlet, and rotatable between a first position, where it is also in fluid communication with another of the inlet and the outlet, and a second position where fluid communication with another of the inlet and outlet is reduced.

12. The valve of claim 11, wherein the position where the fluid communication is reduced is a position where the distributor is not in fluid communication with said at least one inlet/outlet and therefore is essentially a valve-closed position.

13. The valve of claim 11, wherein the distributor is in fluid communication with the inlet and rotatable between a first position, where it is in communication with the outlet, and a second position where fluid communication with said outlet is reduced.

14. The valve of claim 11, wherein at least one of the inner and outer members comprises a distributor and the other of the inner and outer members is a stator that remains stationary in use.

15. The valve of claim 14, wherein the inner member comprises the distributor and the outer member is the stator.

16. A method of manufacturing an actuator or a valve comprising:
providing a piece of material;
cutting a first member from said piece of material; and
cutting a second member from the same piece of material, wherein the material is cut by profile cutting.

17. The method of claim 16, wherein the cutting is in a single straight line or plane, directly from an arbitrary position ‘a’ to an arbitrary position ‘b’ into, and through, the piece material.

18. The method of claim 16, wherein a plurality of separate cuts is performed.

19. The method of claim 16, wherein the first member and second member are cut using Electrical Discharge Machining (EDM).

20. The method of 16, comprising a valve and a distributor, wherein the member comprising the distributor is formed in two parts, one part of the member comprising the distributor and the other part of the member comprising the projections.
